(19) United States
(12) Patent Application Publication
(10) Pub. No.: US 2002/0152370 A1
(43) Pub. Date: Oct. 17, 2002

(54) Method of operating computer, computer operating program, recording medium containing computer operating program, and computer

(75) Inventor: Koji Wada, Hyogo-ken (JP)

Correspondence Address: Joseph R. Keating, Esq., Keating & Bennett LLP, Suite 312, 10400 Eaton Place, Fairfax, VA, 22030, US

(73) Assignee: Japan Marketing Agency Co., Ltd., Osaka-shi (JP)

(21) Appl. No.: 10/122,302

(22) Filed: Apr. 16, 2002

(30) Foreign Application Priority Data
Apr. 16, 2001 (JP) 2001-116874

(51) Int. Cl. G06F 15/177; G06F 9/00; G06F 9/24

(52) U.S. Cl. 713/1

(57) ABSTRACT

A method of operating a computer allows those who lack a high level of expertise in OSes and network technology to operate a computer as a server without difficulty and to take prompt action in the event of troubles. The method of operating a computer includes the steps of booting a computer by using a disk image for starting up a UNIX-based kernel, the disk image being recorded on a read only recording medium, detecting a file system already provided on a rewritable recording medium attached to the computer, detecting free space having no data written thereon out of a section of the file system detected, rendering the detected free space readable and writable of data from the UNIX-based kernel, constructing a partition of a UNIX-based operating system in the free space rendered readable and writable of data from the UNIX-based kernel, storing, into the partition, configuration information for setting details of operation of an application for controlling a facility for the computer to provide, and reading the application for controlling the facility for the computer to provide from the read only recording medium and executing the same based on the configuration information.

### BACKGROUND OF THE INVENTION

1. Field of the Invention

The present invention relates to a method of operating a computer, a computer operating program, a recording medium including a computer operating program, and a computer. In particular, the present invention relates to a method of operating a computer, a computer operating program, a recording medium including a computer operating program, and a computer which facilitates configuring, for example, a server to provide services with high security and stability.

2. Description of the Prior Art

Among operating modes of well-known computers is an Internet server for providing various server services. An Internet server 1, as shown in FIG. 14, is in always-on connection with an Internet communication line 2 via connecting equipment such as a router 3. The Internet server 1 provides various types of services to user terminals 4 which are connected with the Internet or a LAN. The Internet server 1 provides the following server services: a DHCP (Dynamic Host Configuration Protocol) server facility to provide centralized control of network information and to assign IP addresses to network connected equipment automatically; a DNS (Domain Name System) server facility to identify IP addresses corresponding to host names; a WWW server facility to store information that is described in hypertext formats such as HTML documents, SHTML documents, SGML documents, and XML documents, and provide the information on demand by using HTTP (Hyper Text Transfer Protocol); and an e-mail server facility to provide e-mail sending/receiving services using POP (Post Office Protocol) and SMTP (Simple Mail Transfer Protocol). Because of the necessity to provide these server services in a stable condition all of the time, the Internet server 1 is often configured using UNIX™, an operating system (hereinafter, referred to simply as OS) having outstanding system stability and reliability, on a server machine which has high throughput.

Recently, however, low-priced personal computers (hereinafter, referred to simply as PCs) which operate under such OSes as Windows™ and Mac OS™ have been greatly improved in throughput and reliability. High-speed Internet always-on connection environments using ISDN, cable TV lines, ADSL, optical fiber networks, and other suitable devices are available at low cost. In addition, Linux™ and FreeBSD (hereinafter, referred to simply as UNIX-compatible OSes) which run on PCs with stability have been developed. Under the circumstances, an increasing number of small to medium-sized businesses and private users, let alone large-sized businesses, are configuring Internet servers having outstanding cost-performance by installing and operating UNIX-compatible OSes on PCs.

To operate computers as Internet servers by using PCs and UNIX-compatible OSes, the preinstalled OSes such as Windows and Mac OS have typically been removed from the hard disks. Then, the UNIX-compatible OSes and server applications required to provide services are installed on the hard disks of the PCs, followed by configuring for Internet-server use, to configuring the servers.

However, the construction of servers such as Internet servers is difficult for ordinary engineers because a high level of expertise in OSes and network technology is required. This problem is significant for UNIX-based Oses, in particular. Consequently, the construction of servers must be performed by experts.

Moreover, UNIX-based OSes typically require command-based operations, and therefore are unfriendly to ordinary users who are accustomed to GUI-environment operations. This has resulted in frequent occurrence of misoperation.

In general, a plurality of OSes cannot be installed on a single section on a hard disk. Thus, the existing OS must be deleted before a new OS such as a UNIX-compatible OS is installed. For that reason, it is impossible to restore the original state in the event of an installation failure. These various problems have prevented ordinary engineers from constructing Internet servers.

Furthermore, it has been difficult to recover the OSes and applications installed on a hard disk in the event of problems resulting from hard disk failure or cracking such as file rewrites by crackers.

### SUMMARY OF THE INVENTION

In order to overcome the above-described problems, preferred embodiments of the present invention provide a method of operating a computer, a computer operating program, a recording medium including a computer recording program, and a computer which allow those who lack a high level of expertise in OSes and network technology to operate a computer as a server without difficulty and to take prompt action in the event of problems.

According to a first preferred embodiment of the present invention, a method of operating a computer includes the steps of booting a computer by using a disk image for starting up a UNIX-based kernel, the disk image being recorded on a read only recording medium, detecting a file system already provided on a rewritable recording medium attached to the computer, detecting free space having no data out of a section of the file system detected, rendering the detected free space readable and writable with data from the UNIX-based kernel, constructing a partition of a UNIX-based operating system in the free space rendered readable and writable with data from the UNIX-based kernel, storing, into the partition, configuration information for setting details of operation of an application for controlling a facility for the computer to provide, and reading the application for controlling the facility for the computer to provide from the read only recording medium and executing the same based on the configuration information.

According to a second preferred embodiment of the present invention, a method of operating a computer includes the steps of booting a computer by using a disk image for starting up a UNIX-based kernel, detecting a file system already provided on a rewritable recording medium attached to the computer, detecting free space having no data out of a section of the file system detected, rendering the detected free space readable and writable with data from the UNIX-based kernel, constructing a partition of a UNIX-based operating system in the free space rendered readable and writable with data from the UNIX-based kernel, storing, into the partition, the UNIX-based kernel, an application for controlling a facility for the computer to provide, and configuration information for providing details of the operation of the application, and reading the application for controlling the facility for the computer to provide from the partition and executing the same based on the configuration information.

The method of operating a computer according to preferred embodiments of the present invention preferably includes the steps of storing, into the partition, data for displaying a Web screen for acquiring the configuration information and a program for creating or updating the configuration information in accordance with contents acquired on the Web screen, acquiring the content of the configuration information on the Web screen, and creating or updating the configuration information in accordance with the contents of the configuration information acquired on the Web screen.

Preferably, the method of operating a computer further includes the step of rebooting the computer after the step of creating or updating the configuration information in accordance with the contents of the configuration information acquired on the Web screen, wherein the step of reading the application for controlling the facility for the computer to provide from the read only recording medium and executing the same based on the configuration information is performed based on the configuration information created or updated in accordance with the contents of the configuration information acquired on the Web screen.

Preferably, the method of operating a computer according to preferred embodiments of the present invention further includes the step of rebooting the computer after the step of creating or updating the configuration information in accordance with the contents of the configuration information acquired on the Web screen, wherein the step of reading the UNIX-based kernel and the application for controlling the facility for the computer to provide from the partition and executing the same based on the configuration information is performed based on the configuration information created or updated in accordance with the contents of configuration information acquired on the Web screen.

Preferably, in the method of operating a computer according to preferred embodiments of the present invention the facility for the computer to provide is a server facility, and the configuration information includes a configuration item for configuring the operation of the server facility.

Another preferred embodiment of the present invention provides a computer operating program including booting means for booting a computer by using a disk image for starting up a UNIX-based kernel, the disk image being recorded on a read only recording medium, file system detecting means for detecting a file system already provided on a rewritable recording medium attached to the computer, free space detecting means for detecting free space having no data written thereon out of a section of the file system detected by the file system detecting means, free space read/write means for rendering the free space detected by the free space detecting means readable and writable of data from the UNIX-based kernel, partition constructing means for constructing a partition of a UNIX-based operating system in the free space rendered readable and writable of data from the UNIX-based kernel, configuration information storing means for storing, into the partition, configuration information for setting details of operation of an application for controlling a facility for the computer to provide, and execution control means for reading the application for controlling the facility for the computer to provide from the read only recording medium and executing the same based on the configuration information.

Another preferred embodiment of the present invention provides a computer operating program including booting means for booting a computer using a disk image for starting up a UNIX-based kernel, file system detecting means for detecting a file system already provided on a rewritable recording medium attached to the computer, free space detecting means for detecting free space having no data written thereon out of a section of the file system detected by the file system detecting means, free space read/write means for rendering the free space detected by the free space detecting means readable and writable with data from the UNIX-based kernel, partition constructing means for constructing a partition of a UNIX-based operating system in the free space rendered readable and writable of data from the UNIX-based kernel, storing means for storing, into the partition, the UNIX-based kernel, an application for controlling a facility for the computer to provide, and configuration information for setting details of operation of the application, and execution control means for reading the application for controlling the facility for the computer to provide from the partition and executing the same based on the configuration information.

The computer operating program preferably includes data for displaying a Web screen for acquiring the configuration information, configuration information creating/updating means for creating and updating the configuration information in accordance with the contents of the configuration information acquired on the Web screen, and storing means for storing the data for displaying the Web screen and the configuration information updating/creating means into the partition.

Preferably, the computer operating program further includes rebooting means for rebooting the computer after the configuration information is created or updated in accordance with the contents of the configuration information acquired on the Web screen, and execution control means for reading the application for controlling the facility for the computer to provide from the read only recording medium and executing the same based on the configuration information created or updated by the configuration information creating/updating means.

The computer operating program preferably further includes rebooting means for rebooting the computer after the configuration information is created or updated in accordance with the contents of the configuration information acquired on the Web screen, and execution control means for reading the UNIX-based kernel and the application for controlling the facility for the computer to provide from the partition and executing the same based on the configuration information created or updated by the configuration information creating/updating means, the UNIX-based kernel and the application being written in the partition.

Preferably, in the computer operating program, the facility for the computer to provide is a server facility, and the configuration information includes a configuration item for configuring the operation of the server facility.

Another preferred embodiment of the present invention provides a recording medium including the computer operating program described above.

Another preferred embodiment of the present invention provides a computer including a booting unit for booting the computer using a disk image for starting up a UNIX-based kernel, the disk image being recorded on a read only recording medium, a file system detecting unit for detecting a file system already provided on a rewritable recording medium attached to the computer, a free space detecting unit for detecting free space having no data provided thereon out of a section of the file system detected by the file system detecting unit, a free space read/write unit for rendering the free space detected by the free space detecting unit readable and writable of data from the UNIX-based kernel, a partition constructing unit for constructing a partition of a UNIX-based operating system in the free space rendered readable and writable of data from the UNIX-based kernel, a configuration information storing unit for storing, into the partition, configuration information for setting details of operation of an application for controlling a facility for the computer to provide, and an execution control unit for reading the application for controlling the facility for the computer to provide from the read only recording medium and executing the same based on the configuration information.

Another preferred embodiment of the present invention provides a computer including a booting unit for booting the computer using a disk image for starting up a UNIX-based kernel, a file system detecting unit for detecting a file system already provided on a rewritable recording medium attached to the computer, a free space detecting unit for detecting free space having no data provided thereon out of a section of the file system detected by the file system detecting unit, a free space read/write unit for rendering the free space detected by the free space detecting unit readable and writable of data from the UNIX-based kernel, a partition constructing unit for constructing a partition of a UNIX-based operating system in the free space rendered readable and writable of data from the UNIX-based kernel, a storing unit for storing, into the partition, the UNIX-based kernel, an application for controlling a facility for the computer to provide, and configuration information for setting details of operation of the application, and an execution control unit for reading the application for controlling the facility for the computer to provide from the partition and executing the same based on the configuration information.

The computer preferably includes data for displaying a Web screen for acquiring the configuration information, a configuration information creating/updating unit for creating and updating the configuration information in accordance with the contents of the configuration information acquired on the Web screen, and a storing unit for storing the data for displaying the Web screen and the configuration information updating/creating unit into the partition.

Additionally, the computer preferably further includes a rebooting unit for rebooting the computer after the configuration information is created or updated in accordance with the contents of the configuration information acquired on the Web screen, and an execution control unit for reading the application for controlling the facility for the computer to provide from the read only recording medium and executing the same based on the configuration information created or updated by the configuration information creating/updating unit.

More preferably, the computer further includes a rebooting unit for rebooting the computer after the configuration information is created or updated in accordance with the contents of the configuration information acquired on the Web screen, and an execution control unit for reading the UNIX-based kernel and the application for controlling the facility for the computer to provide from the partition and executing the same based on the configuration information created or updated by the configuration information creating/updating unit, the UNIX-based kernel and the application being written in the partition.

Preferably, in the computer, the facility for the computer to provide is a server facility, and the configuration information includes a configuration item for configuring the operation of the server facility.

The foregoing and other elements, characteristics, features, and advantages of the present invention will become more apparent from the following detailed description of preferred embodiments when read in conjunction with the drawings.

### BRIEF DESCRIPTION OF THE DRAWINGS

FIG. 1 is a flowchart showing the flow of a preferred embodiment of the method of operating a computer according to the present invention.

FIG. 2 is a schematic block diagram showing a PC to construct a server.

FIG. 3 is a schematic diagram showing the contents of a CD-ROM that includes a computer operating program.

FIG. 4 is a schematic diagram showing the contents of the hard disk.

FIG. 5 is a schematic diagram showing the used and free areas of the hard disk.

FIG. 6 is a conceptual diagram showing created subdirectories and extended file information files stored in the respective subdirectories.

FIG. 7 is a schematic diagram showing a menu screen of configuration information acquiring screens displayed.

FIG. 8 is a schematic diagram showing a configuration information acquiring screen for network configuration displayed.

FIG. 9 is a schematic diagram showing a configuration information acquiring screen for name server configuration displayed.

FIG. 10 is a schematic diagram showing a configuration input screen for mail server configuration displayed.

FIG. 11 is a schematic diagram showing a configuration information acquiring screen for Web server configuration displayed.

FIG. 12 is a schematic diagram showing a configuration information acquiring screen for DHCP server configuration displayed.

FIG. 13 is a flowchart showing the flow of another preferred embodiment of the method of operating a computer according to the invention.

FIG. 14 is a schematic diagram showing the operation mode of a conventional Internet server.

### DETAILED DESCRIPTION OF PREFERRED EMBODIMENTS

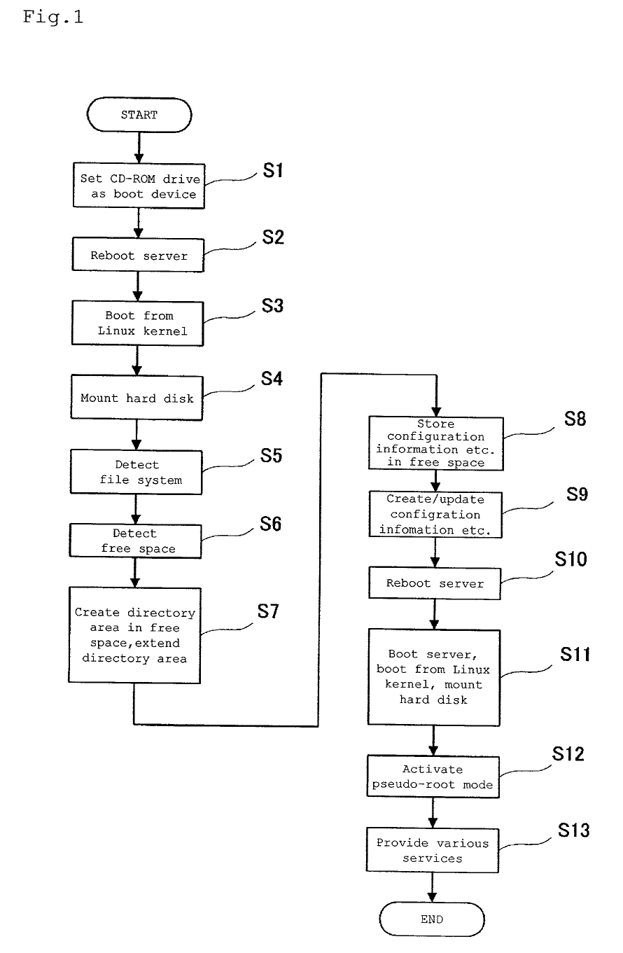

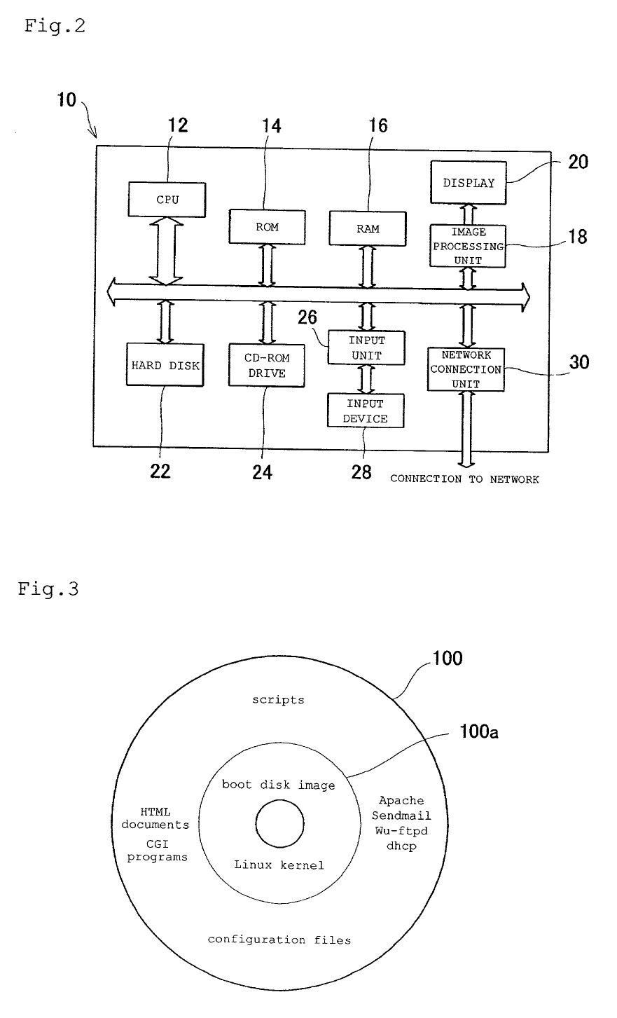

FIG. 1 is a flowchart showing the flow of a preferred embodiment of the method of operating a computer according to the present invention. FIG. 2 is a schematic block diagram showing a PC to construct a server. FIG. 3 is a conceptual diagram showing the contents of a CD-ROM that contains a computer operating program.

The server PC (hereinafter, referred to simply as server) 10 includes a CPU 12. The CPU 12 is a central processing unit for performing operations when the server 10 executes various types of processing. The CPU 12 is connected with a ROM 14. The ROM 14 is memory for storing a basic input/output processing program (hereinafter, referred to simply as BIOS) to be executed when booting the server 10. The CPU 12 is also connected with a RAM 16. The RAM 16 is a memory for temporarily storing programs and data to be used when the CPU 12 executes various types of processing.

The CPU 12 is connected with an image processing unit 18. The image processing unit 18 creates screen display data based on the results of operations by the CPU 12. The image processing unit 18 is connected with a display 20. The display 20 displays a screen based on the screen display data created by the image processing unit 18.

The CPU 12 is connected with a hard disk 22. The hard disk 22 stores programs and data used during the execution of various operations, as well as an OS or OSes used by the server 10. The hard disk 22 stores data created by the operations of the CPU 12.

Note that a hard disk is logically divided into a plurality of sections by creating section information, i.e. information so-called “disk label” or “partition table,” in the MBR (master boot record) of the hard disk. Each of the sections is treated as an individual drive. While such a section is referred to differently according to OSes, for example, “a partition” in Windows-based OSes and “a slice” in BSD-based OSes, the term “a section” is used in the preferred embodiments according to the present invention.

Furthermore, a logical drive created within the above-mentioned section is referred to differently according to OSes, for example, “a logical drive” or “a partition,” the term “a partition” is used in the preferred embodiments according to the present invention.

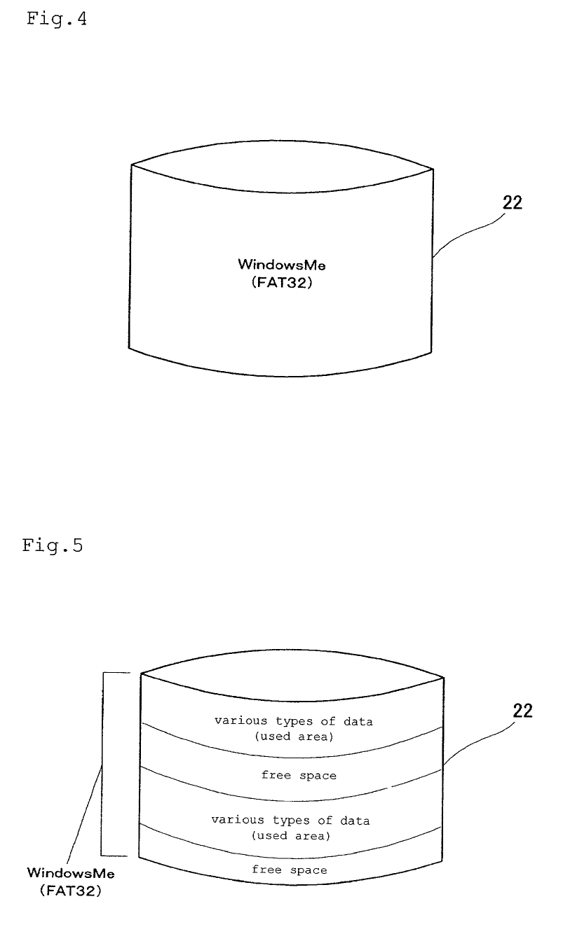

As shown in FIG. 4, the entire section of the hard disk 22 is formatted with VFAT32 which is a file system used in Windows Me. Windows Me is installed on the hard disk 22. When the server 10 is booted with the hard disk 22 as the boot drive, the server 10 starts up using Windows Me as the OS.

The CPU 12 is also connected with a CD-ROM drive 24. The CD-ROM drive 24 reads various types of data from a CD-ROM, which is a read only recording medium.

Incidentally, which boot device this server 10 starts up the OS from, the hard disk 22 or the CD-ROM drive 24, is set by the BIOS stored in the ROM 14.

The CPU 12 is connected with an input unit 26. The input unit 26 is an interface for connecting an input device 28 to be described later. The input unit 26 inputs, to the CPU 12, various types of instruction signals and various types of data that are input from the input device 28. The input unit 26 is connected with the input device 28. The input device 28 includes a keyboard and a mouse. The input device 28 is used to input instruction signals and various character data.

The CPU 12 is connected with a network connection unit 30. The network connection unit 30 is a device for exchanging various types of data through an Internet line. The network connection unit 30 is typically a LAN card, whereas other devices such as a modem and a terminal adaptor may be used instead.

Description will now be provided of the CD-ROM which includes a computer operating program. As shown in FIG. 3, a CD-ROM 100 includes a disk image 100a, BIND, Apache, Sendmail, Wu-ftpd, dhcp, and other applications. The disk image 100a is used to start up a UNIX-based kernel. BIND, Apache, Sendmail, Wu-ftpd, and dhcp are applications that control facilities for the server 10 to provide, for example, a DNS server, a WWW server, a mail server, an FTP server, and a DHCP server, respectively. The CD-ROM 100 also includes configuration files, HTML documents, and CGI programs. The configuration files include configuration information for setting the details of operation of the foregoing applications. The HTML documents display Web screens for acquiring the configuration information. The CGI programs create or update the configuration information in accordance with the contents acquired on the Web screens. These data and applications stored on the CD-ROM 100 are processed by programs such as the scripts stored on the CD-ROM 100, thereby configuring the server 10 so as to provide server services.

Hereinafter, description will be provided of the method of configuring a server by using the CD-ROM 100.

Initially, at step S1, the CD-ROM drive 24 is set as the boot device of the server 10. This step is unnecessary if the CD-ROM drive 24 is already set as the boot device of the server 10.

At step S2, the server 10 is rebooted with the CD-ROM 100 loaded in the CD-ROM drive 24.

The rebooted server 10 checks the CD-ROM drive 24 for the CD-ROM 100. If the CD-ROM drive 24 is loaded with the CD-ROM 100, the server 10 boots using the boot disk image stored on the CD-ROM 100. As a result, the kernel of Linux, a UNIX-compatible OS, is read into the RAM 16 (step S3). Incidentally, when the server 10 of this preferred embodiment is equipped with both an IDE CD-ROM drive and a SCSI CD-ROM drive as CD-ROM drives 24, the IDE CD-ROM drive is checked first for the CD-ROM 100 and then the SCSI CD-ROM drive is checked for the CD-ROM.

Next, at step S4, the server 10 is searched for the equipped hard disk 22. The hard disk 22 is mounted such that the hard disk 22 is controlled by the Linux kernel.

At step S5, the file system already provided on the hard disk 22 is detected by referring to the disk label of the hard disk 22. In this preferred embodiment, the order of detection of the file system is preferably as follows: FAT for use in MS-DOS™; VFAT16/32 for use in Windows 95, Windows 98, and Windows Me; and NTFS for use in Windows NT. In the present preferred embodiment, the entire section of the hard disk 22 is formatted with VFAT32 which is the file system used in Windows Me. Hence, VFAT32 is detected.

At step S6, as shown in FIG. 5, free space having no data written thereon is detected out of the section of the file system detected.

At step S7, a directory area having an equivalent structure to that of a partition that is typically created in Linux is created in the free space of the file system detected at step S6. The directory area created is then extended such that the directory area is controlled as if a Linux partition is under ext2, which is the standard file system in Linux.

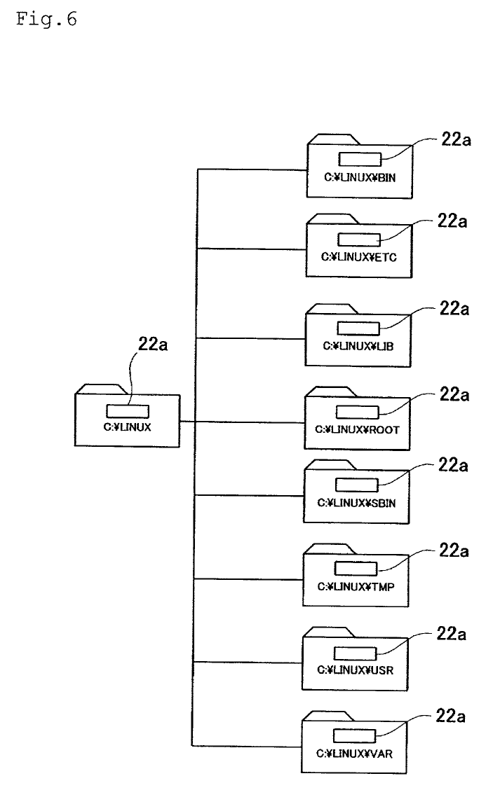

The processing executed at step S7 will be described in more detail below. Initially, directories having an equivalent structure to that of a partition to be typically created in Linux are created in the free space of the file system as shown in FIG. 6. In this preferred embodiment, the hard disk 22 is configured in the file system VFAT32. Thus, when Windows Me is booted to check the directories created, the following subdirectories will be found:

C:\LINUX\BIN,

C:\LINUX\ETC,

C:\LINUX\LIB,

C:\LINUX\ROOT,

C:\LINUX\SBIN,

C:\LINUX\TMP,

C:\LINUX\USR, and

C:\LINUX\VAR.

Note that the foregoing directories created are different from those of a partition that is typically created in Linux, or the following:

C:\BIN,

C:\ETC,

C:\LIB,

C:\ROOT,

C:\SBIN,

C:\TMP,

C:\USR, and

C:\VAR.

The reason for the difference is to prevent such directories as bin and tmp, if already exist on the drive C: in Windows Me, from eroding the directory area.

Next, the directory area created is extended such that the directory area is handled as if a Linux partition is under ext2, which is the standard file system in Linux. For this purpose, as shown in FIG. 6, an extended file information file 22a is created in each of the subdirectories created. The extended file information files store information directory by directory and file by file. The information to be stored includes DOS file names, file sizes, update date-and-time information, and file attribute information which are recorded file by file, directory by directory in FAT, VFAT16/32, and NTFS, as well as long file names, file attribute information, file owner information, file link information and special file information which are recorded file by file, directory by directory in ext2. These extended file information files are updated automatically upon each file operation or directory operation.

At step S8, the configuration files or configuration information for setting the details of operation of the applications that control the server facilities for the server 10 to provide, the HTML documents for displaying the Web screens for acquiring the configuration information, and the CGI programs for creating and updating the configuration information in accordance with the contents acquired on the Web screens are read from the CD-ROM 100 to the free space detected at step S6. The configuration files, the HTML documents, and the CGI programs are stored in the extended free space. In this preferred embodiment, the configuration files to be stored include those of the DNS server BIND, the WWW server Apache, the mail server Sendmail, the FTP server Wu-ftpd, and the DHCP server dhcp.

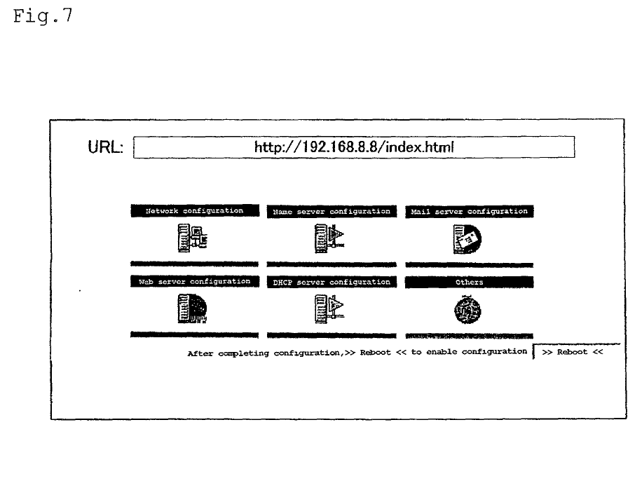

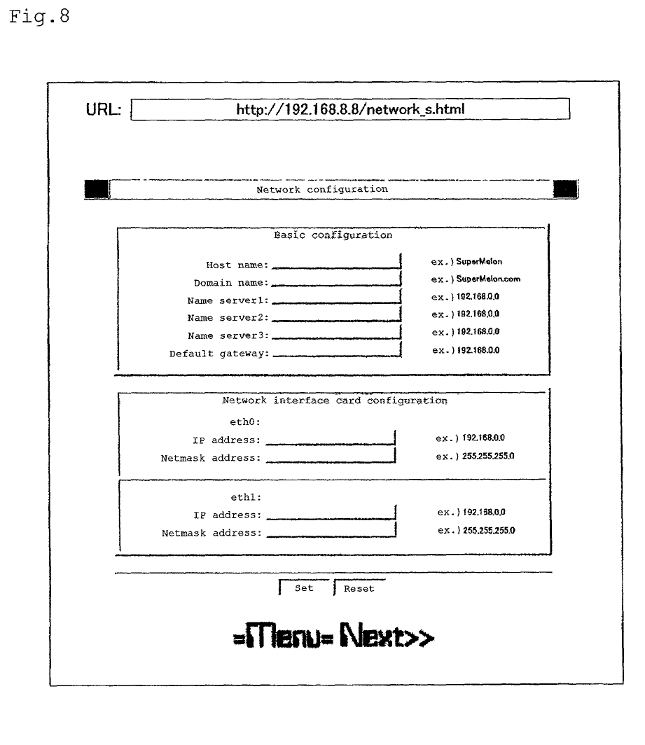

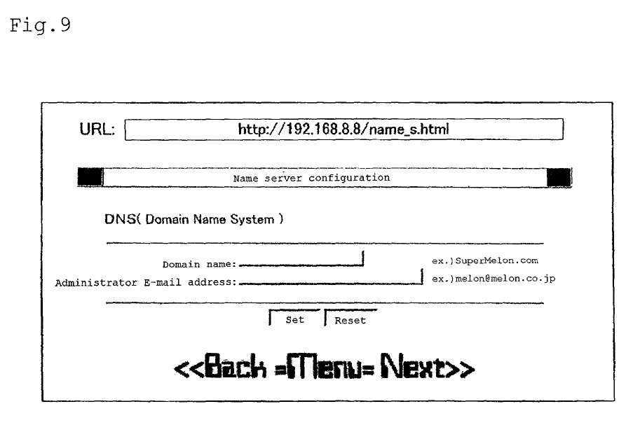

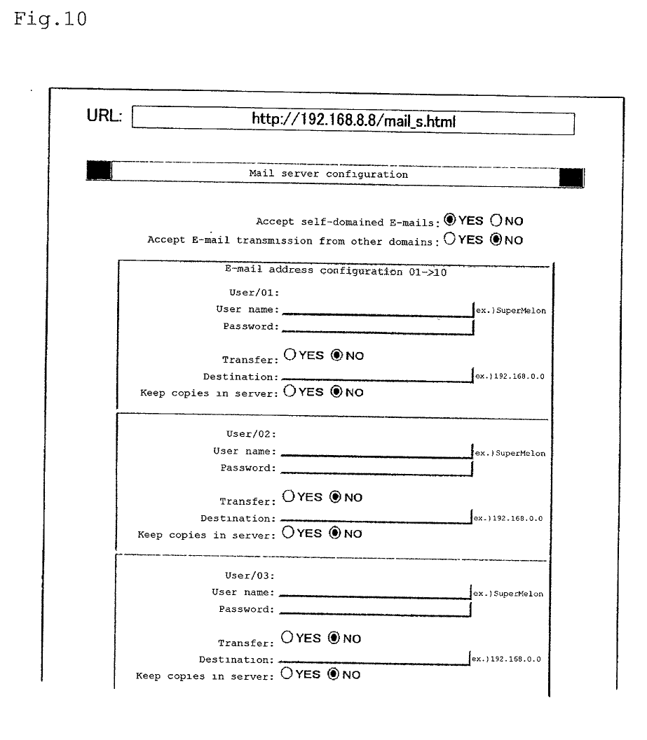

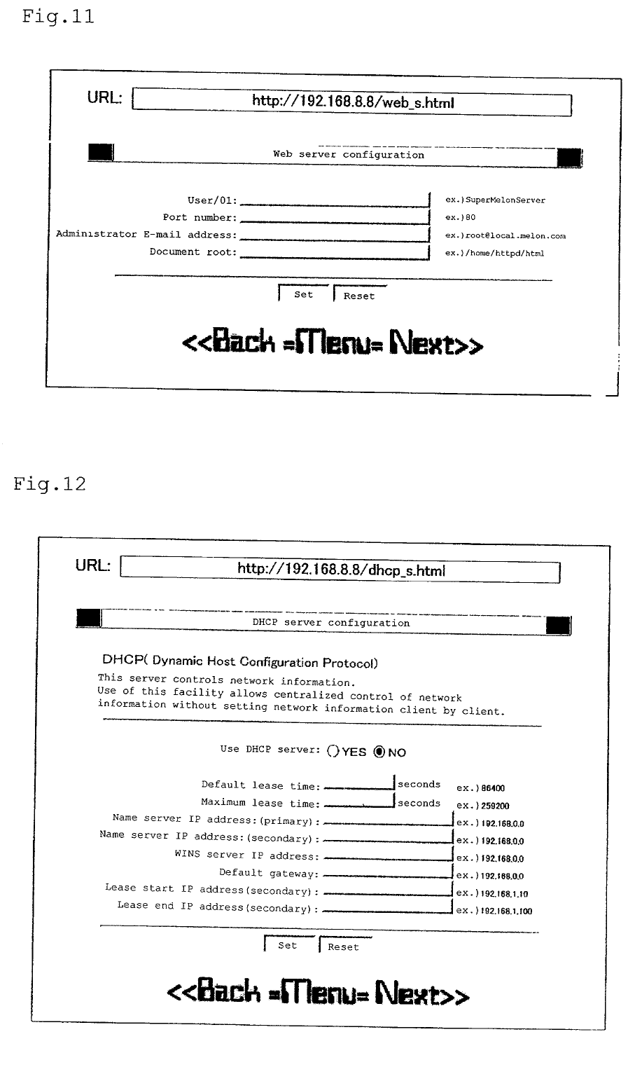

At step S9, the WWW server recorded on the CD-ROM 100 is activated. Netscape Navigator™, a WWW browser recorded on the CD-ROM 100, is used to input configuration information on Web screens for inputting configuration information, thereby creating/updating the configuration files. In the input operation, the IP address of the server 10 is entered in the URL input field of the WWW browser as shown in FIG. 7, wherein a menu screen recorded as the top page is displayed. From the menu screen, configuration information acquiring pages such as shown in FIGS. 8-12 are displayed. Any configuration information is input on the respective configuration information acquiring pages and “Set” button displayed on-screen is clicked to create/update the respective configuration files. In this preferred embodiment, the server 10 is given an IP address of “192.168.8.8”. Then, “192.168.8.8” is entered to the URL input field of the WWW browser to display the menu screen shown in FIG. 7.

After the configuration information on the variety of servers for the server 10 to provide services from is acquired and the configuration files are created/updated at step S9, “Reboot” button displayed on the menu screen is clicked to reboot the server 10 (step S10).

The rebooted server 10 starts up as in step S3, S4, and S5. More specifically, the server 10 boots from the boot disk image 100a recorded on the CD-ROM 100, reading the kernel into the RAM 16. The server 10 is searched for the equipped hard disk 22, and the hard disk 22 is mounted such that the hard disk 22 is controlled by the Linux kernel. The file system already provided on the hard disk 22 is detected by referring to the disk label of the hard disk 22 (step S11).

Next, the section of the file system detected by the kernel is searched for a directory “linux”. Then, the section of the file system detected is searched for a directory “/linux/etc”. In this preferred embodiment, VFAT32 is detected. Hence, directories “C:\LINUX” and “C:\LINUX\ETC” are searched for. If these directories are present, a pseudo-root mode is activated such that “C:\LINUX” in Windows Me is provided on the root directory in the typical UNIX partition configuration (step S12). Incidentally, the pseudo-root mode refers to the processing in which any directory area in the section of a file system other than ext2 is rendered equivalent to the root directory of the typical UNIX partition configuration.

Based on the configuration files created/updated at step S9, the server 10 activates the DNS server BIND, the WWW server Apache, the mail server Sendmail, the FTP server Wu-ftpd, the DHCP server dhcp, and other suitable applications to provide services (step S13). Incidentally, in the configuration files created/updated at step S9, the CD-ROM 100 is set as the partition to read Apache, Sendmail, Wu-ftpd, and dhcp from. Files and others which must be stored due to the provision of services are stored into the directories “C:\LINUX” and below as appropriate.

Consequently, the server 10 is easily configured as an Internet server using Linux, a UNIX-compatible OS, without deleting the existing file system structure. In addition, such programs as the boot kernel and the server applications are read from the CD-ROM which is a read only recording medium. Thus, even in the event of hard disk failure, a new server is easily configured by replacing the hard disk and rebooting from the CD-ROM 100. Moreover, since the boot kernel, the server applications, and other programs are read from the CD-ROM which is a read only recording medium, the possibility of cracking such as program rewriting by crackers is eliminated. Further, the server 10 is easily restored to an existing OS such as Windows Me simply by deleting directories “C:/LINUX” and booting server 10 from the hard drive 22.

In this preferred embodiment, the file systems to be detected are preferably FAT, VFAT16, VFAT32, and NTFS. The file systems to be detected are, however, not limited thereto but may include various file systems such as HFS, HPFS, EXT, and MINIX and other suitable file systems.

In this preferred embodiment, the WWW browser is preferably used to acquire the configuration information. The method of acquisition is not limited thereto, however. For example, standard settings or current settings may be displayed as initial values so as to prompt user input according to a certain procedure.

In this preferred embodiment, an Internet server is described in particular. The construction is not limited thereto, however. For example, a server not connected to the Internet, such as one on a corporate LAN, may be constructed.

In this preferred embodiment, the facilities for the computer to provide are preferably a DNS server, a WWW server, a mail server, an FTP server, and a DHCP server. The facilities to provide are, however, not limited thereto but may include such server facilities as a file server and the X server for use in X Window System. In addition, the facilities for the computer to provide need not be server services. X client applications for personal use may also be provided.

In this preferred embodiment, Linux is preferably used as the UNIX-based kernel. The kernel is not limited thereto, however. For example, UNIX-compatible OSes such as FreeBSD, NetBSD, and OpenBSD, and UNIX-based OSes and others may be used instead.

In this preferred embodiment, the computer-readable recording medium including the programs is preferably a CD-ROM. The recording medium is not limited thereto, however. For example, DVDs and write-protected rewritable recording media and other suitable recording media may be used as well.

In this preferred embodiment, the WWW browser is activated by the server itself to input the configuration information. The method of inputting the configuration information is not limited thereto, however. For example, a client terminal may be connected to the server over a LAN so that the configuration information is input from a WWW browser activated on the client terminal. In this case, the CD-ROM need not include any WWW browser.

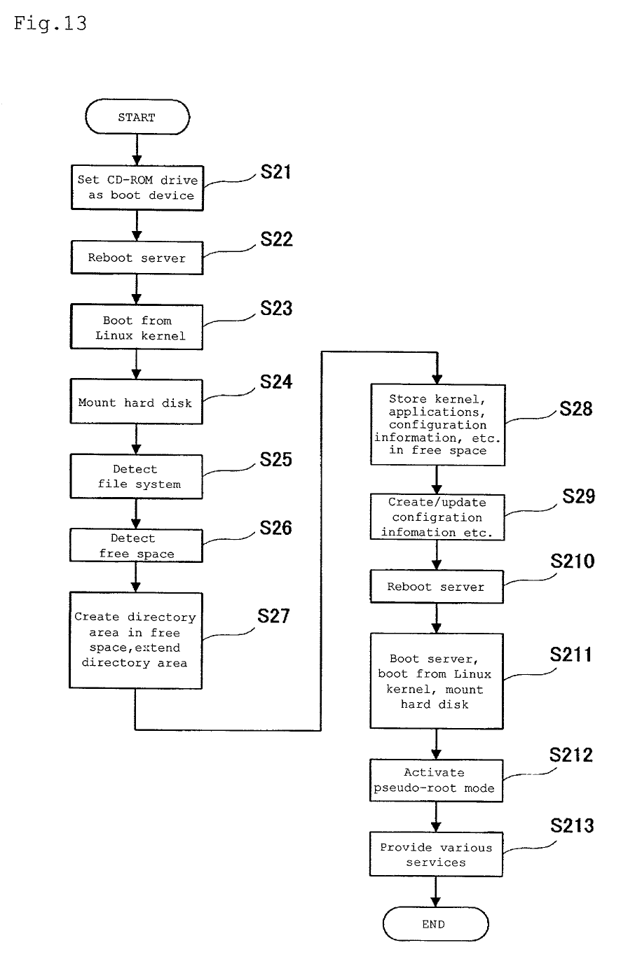

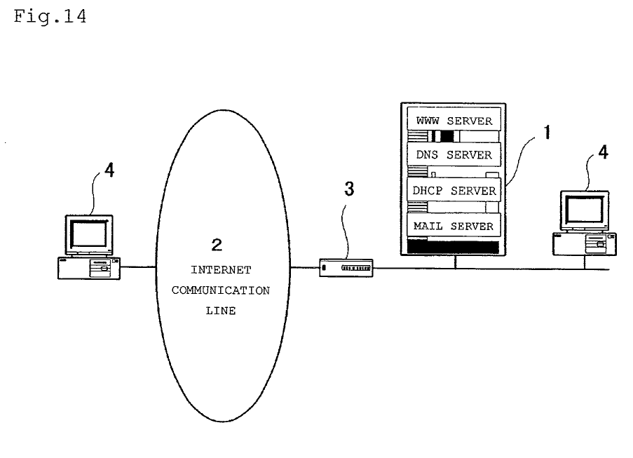

Hereinafter, another preferred embodiment of the present invention will be described with reference to FIG. 13.

Initially, at step S21, the CD-ROM drive 24 is set as the boot device of the server 10. Like step S1, this step is unnecessary if the CD-ROM drive 24 is already set as the boot device of the server 10.

At step S22, the server 10 is rebooted with the CD-ROM 100 loaded in the CD-ROM drive 24.

The rebooted server 10 checks the CD-ROM drive 24 for the CD-ROM. If the CD-ROM drive 24 is loaded with the CD-ROM, the server 10 boots using the boot disk image 10astored on the CD-ROM 100. As a result, the kernel of Linux is read into the RAM 16 (step S23). Incidentally, when the server 10 of this preferred embodiment is equipped with both an IDE CD-ROM drive and a SCSI CD-ROM drive as CD-ROM drives 24, it checks the IDE CD-ROM drive for the CD-ROM first, and then checks the SCSI CD-ROM drive for the CD-ROM.

Next, at step S24, the server 10 is searched for the equipped hard disk 22. The hard disk 22 is provided such that the hard disk 22 is controlled by the Linux kernel.

At step S25, the file system already provided on the hard disk 22 is detected by referring to the disk label of the hard disk 22 as in step S5. In this preferred embodiment, again, the order of detection of the file system is preferably as follows: FAT for use in MS-DOS™; VFAT16/32 for use in Windows 95, Windows 98, and Windows Me; and NTFS for use in Windows NT. In the present preferred embodiment, the entire section of the hard disk 22 is formatted with VFAT32 which is the file system used in Windows Me. Hence, VFAT32 is detected.

At step S26, free space having no data written thereon is detected out of the section of the detected file system as in step S6.

At step S27, a directory area having an equivalent structure to that of a partition to be typically created by Linux is created in the free space of the file system detected at step S26. The directory area created is then extended such that the directory area is controlled as if a Linux partition is under ext2, which is the standard file system in Linux. The processing to be executed at step S27 is the same as that of step S7.

At step S28, the Linux kernel, application bodies, configuration files, HTML documents, and CGI programs are read from the CD-ROM 100 and stored in the free space detected at step S26. The application bodies include a DNS server BIND, a WWW server Apache, a mail server Sendmail, an FTP server Wu-ftpd, a DHCP server dhcp, and a WWW browser Netscape Navigator. The configuration files include configuration information for setting the details of operation of the respective server applications. The HTML documents display Web screens for acquiring the configuration information. The CGI programs create or update the configuration information in accordance with the contents acquired on the Web screens.

At step S29, the WWW server stored in the free space is activated. Netscape Navigator, the WWW browser recorded on the CD-ROM, is used to input configuration information on the Web screens for inputting the configuration information, shown in FIGS. 7-12, to create/update the configuration files. This input operation is performed by the same procedure as that described in step S9.

After the configuration information on the variety of servers for the server 10 to provide service is acquired and the configuration files are created/updated at step S29, a “Reboot” button displayed on the menu screen is clicked to reboot the server 10 (step S210).

The rebooted server 10 boots from the boot disk image 100a stored in the free space, reading the kernel into the RAM 16. The server 10 is searched for the equipped hard disk 22, and the hard disk 22 is provided such that the hard disk 22 is controlled by the Linux kernel. The file system already provided on the hard disk 22 is detected by referring to the disk label of the hard disk 22 (step S211).

Next, the section of the file system detected by the kernel is searched for a directory “linux”. Then, the section of the file system detected is searched for a directory “/linux/etc”. In this preferred embodiment, VFAT32 is detected. Hence, directories “C:\LINUX” and “C:\LINUX\ETC” are searched for. If these directories are present, a pseudo-root mode is activated such that “C:\LINUX” in Windows Me is provided on the root directory in the typical UNIX partition configuration (step S212).

Based on the configuration files created/updated at step S29, the server 10 activates the DNS server BIND, the WWW server Apache, the mail server Sendmail, the FTP server Wu-ftpd, the DHCP server dhcp, and other suitable applications to provide services (step S213). Incidentally, in the configuration files created/updated at step S29, the directory area created at step S27 is set as the partition from which Apache, Sendmail, Wu-ftpd, and dhcp are read. Files and others that must be stored due to the provision of services are stored into the directories “C:\LINUX” and below, which are operated in the pseudo-root mode.

Consequently, the server 10 is easily configured as an Internet server using Linux, a UNIX-compatible OS, without deleting the existing file system structure. The server 10 is easily restored to an existing OS such as Windows Me simply by deleting directories “C:/LINUX” and booting server 10 from the hard drive 22.

In this preferred embodiment, the file systems to be detected are FAT, VFAT16, VFAT32, and NTFS. The file systems to be detected are, however, not limited thereto but may include various file systems such as HFS, HPFS, EXT, and MINIX.

In this preferred embodiment, the WWW browser is used to acquire the configuration information. The method of acquisition is not limited thereto, however. For example, standard settings or current settings may be displayed as initial values so as to prompt user input according to a certain procedure.

In this preferred embodiment, the configuration of an Internet server is preferably provided. The construction is not limited thereto, however. For example, a server not connected to the Internet, such as one on a corporate LAN, may be constructed.

In this preferred embodiment, the facilities for the computer to provide are preferably a DNS server, a WWW server, a mail server, an FTP server, and a DHCP server. The facilities to provide are, however, not limited thereto but may include such server facilities as a file server and the X server for use in X Window System. In addition, the facilities for the computer to provide need not be server services. X client applications and the like for personal use may also be provided.

In this preferred embodiment, Linux is preferably used as the UNIX-based kernel. The kernel is not limited thereto, however. For example, UNIX-compatible OSes such as FreeBSD, NetBSD, and OpenBSD, and UNIX-based OSes may be used instead.

In this preferred embodiment, the computer-readable recording medium including the programs is preferably a CD-ROM. The recording medium is not limited thereto, however. For example, DVDs and write-protected rewritable recording media and other suitable recording media may be used as well.

In this preferred embodiment, the WWW browser is activated by the server itself to input the configuration information. The method of inputting the configuration information is not limited thereto, however. For example, a client terminal may be connected to the server over a LAN so that the configuration information is input from a WWW browser activated on the client terminal. In this case, the CD-ROM need not include any WWW browser.

As has been described, according to the method of operating a computer, the computer operating program, the recording medium including a computer operating program, and the computer of the present invention, it is possible to provide a method of operating a computer, a computer operating program, a recording medium containing a computer operating program, and a computer which permits those who lack a high level of expertise in OSes and network technology to operate a computer as a server without difficulty and to take prompt action in the event of troubles.

While preferred embodiments of the invention have been disclosed, various modes of carrying out the principles disclosed herein are contemplated as being within the scope of the following claims. Therefore, it is understood that the scope of the present invention is not to be limited except as otherwise set forth in the claims.

What is claimed is:

1. A method of operating a computer, comprising the steps of:
booting a computer by using a disk image for starting up a UNIX-based kernel, said disk image being recorded on a read only recording medium;
detecting a file system already provided on a rewritable recording medium attached to said computer;
detecting free space having no data written thereon out of a section of said file system that is detected;
rendering said detected free space readable and writable of data from said UNIX-based kernel;
constructing a partition of a UNIX-based operating system in said free space rendered readable and writable of data from said UNIX-based kernel;
storing, into said partition, configuration information for setting details of operation of an application for controlling a facility for said computer to provide; and
reading said application for controlling the facility for said computer to provide from said read only recording medium and executing the same based on said configuration information.

2. The method of operating a computer according to claim 1, further comprising the steps of:
storing, into said partition, data for displaying a Web screen for acquiring said configuration information and a program for creating or updating said configuration information in accordance with contents acquired on said Web screen;
acquiring contents of said configuration information on said Web screen; and
creating or updating said configuration information in accordance with the contents of said configuration information acquired on said Web screen.

3. The method of operating a computer according to claim 2, further comprising the step of:
rebooting said computer after the step of creating or updating said configuration information in accordance with the contents of said configuration information acquired on said Web screen, wherein
the step of reading said application for controlling the facility for said computer to provide from said read only recording medium and executing the same based on said configuration information is performed based on said configuration information created or updated in accordance with the contents of said configuration information acquired on said Web screen.

4. The method of operating a computer according to claim 2, further comprising the step of rebooting said computer after the step of creating or updating said configuration information in accordance with the contents of said configuration information acquired on said Web screen, wherein the step of reading said UNIX-based kernel and said application for controlling the facility for said computer to provide from said partition and executing the same based on said configuration information is performed based on said configuration information created or updated in accordance with the contents of configuration information acquired on said Web screen.

5. The method of operating a computer according to claim 1, wherein:
the facility for said computer to provide is a server facility; and
said configuration information includes a configuration item for configuring the operation of said server facility.

6. A method of operating a computer, comprising the steps of:
booting a computer by using a disk image for starting up a UNIX-based kernel;
detecting a file system already provided on a rewritable recording medium attached to said computer;
detecting free space having no data written thereon out of a section of said file system detected;
rendering said detected free space readable and writable of data from said UNIX-based kernel;
constructing a partition of a UNIX-based operating system in said free space rendered readable and writable of data from said UNIX-based kernel;
storing, into said partition, said UNIX-based kernel, an application for controlling a facility for said computer to provide, and configuration information for setting details of operation of said application; and
reading said application for controlling the facility for said computer to provide from said partition and executing the same based on said configuration information.

7. The method of operating a computer according to claim 6, further comprising the steps of:
storing, into said partition, data for displaying a Web screen for acquiring said configuration information and a program for creating or updating said configuration information in accordance with contents acquired on said Web screen;
acquiring contents of said configuration information on said Web screen; and
creating or updating said configuration information in accordance with the contents of said configuration information acquired on said Web screen.

8. The method of operating a computer according to claim 7, further comprising the step of rebooting said computer after the step of creating or updating said configuration information in accordance with the contents of said configuration information acquired on said Web screen, wherein the step of reading said application for controlling the facility for said computer to provide from said read only recording medium and executing the same based on said configuration information is performed based on said configuration information created or updated in accordance with the contents of said configuration information acquired on said Web screen.

9. The method of operating a computer according to claim 7, further comprising the step of rebooting said computer after the step of creating or updating said configuration information in accordance with the contents of said configuration information acquired on said Web screen, wherein the step of reading said UNIX-based kernel and said application for controlling the facility for said computer to provide from said partition and executing the same based on said configuration information is performed based on said configuration information created or updated in accordance with the contents of configuration information acquired on said Web screen.

10. The method of operating a computer according to claim 6, wherein:
the facility for said computer to provide is a server facility; and
said configuration information includes a configuration item for configuring the operation of said server facility.

11. A computer operating program comprising:
booting means for booting a computer by using a disk image for starting up a UNIX-based kernel, said disk image being recorded on a read only recording medium;
file system detecting means for detecting a file system already provided on a rewritable recording medium attached to said computer;
free space detecting means for detecting free space having no data written thereon out of a section of said file system detected by said file system detecting means;
free space read/write means for rendering said free space detected by said free space detecting means readable and writable of data from said UNIX-based kernel;
partition constructing means for constructing a partition of a UNIX-based operating system in said free space rendered readable and writable of data from said UNIX-based kernel;
configuration information storing means for storing, into said partition, configuration information for setting details of operation of an application for controlling a facility for said computer to provide; and
execution control means for reading said application for controlling the facility for said computer to provide from said read only recording medium and executing the same based on said configuration information.

12. The computer operating program according to claim 11, further comprising:
data for displaying a Web screen for acquiring said configuration information;
configuration information creating and updating means for creating or updating said configuration information in accordance with the contents of said configuration information acquired on said Web screen; and
storing means for storing said data for displaying said Web screen and said configuration information updating and creating means into said partition.

13. The computer operating program according to claim 12, further comprising:
rebooting means for rebooting said computer after said configuration information is created or updated in accordance with the contents of said configuration information acquired on said Web screen; and
execution control means for reading said application for controlling the facility for said computer to provide from said read only recording medium and executing the same based on said configuration information created or updated by said configuration information creating and updating means.

14. The computer operating program according to claim 12, further comprising:
rebooting means for rebooting said computer after said configuration information is created or updated in accordance with the contents of said configuration information acquired on said Web screen; and
execution control means for reading said UNIX-based kernel and said application for controlling the facility for said computer to provide from said partition and executing the same based on said configuration information created or updated by said configuration information creating and updating means, said UNIX-based kernel and said application being written in said partition.

15. The computer operating program according to claim 11, wherein:
the facility for said computer to provide is a server facility; and
said configuration information includes a configuration item for configuring the operation of said server facility.

16. A recording medium containing the computer operating program according to claim 11.

17. A computer operating program comprising:
booting means for booting a computer by using a disk image for starting up a UNIX-based kernel;
file system detecting means for detecting a file system already provided on a rewritable recording medium attached to said computer;
free space detecting means for detecting free space having no data written thereon out of a section of said file system detected by said file system detecting means;
free space read/write means for rendering said free space detected by said free space detecting means readable and writable of data from said UNIX-based kernel;
partition constructing means for constructing a partition of a UNIX-based operating system in said free space rendered readable and writable of data from said UNIX-based kernel;
storing means for storing, into said partition, said UNIX-based kernel, an application for controlling a facility for said computer to provide, and configuration information for setting details of operation of said application; and
execution control means for reading said application for controlling the facility for said computer to provide from said partition and executing the same based on said configuration information.

18. The computer operating program according to claim 17, further comprising:
data for displaying a Web screen for acquiring said configuration information;
configuration information creating and updating means for creating or updating said configuration information in accordance with the contents of said configuration information acquired on said Web screen; and
storing means for storing said data for displaying said Web screen and said configuration information creating and updating means into said partition.

19. The computer operating program according to claim 18, further comprising:
rebooting means for rebooting said computer after said configuration information is created or updated in accordance with the contents of said configuration information acquired on said Web screen; and
execution control means for reading said application for controlling the facility for said computer to provide from said read only recording medium and executing the same based on said configuration information created or updated by said configuration information creating and updating means.

20. The computer operating program according to claim 18, comprising:
rebooting means for rebooting said computer after said configuration information is created or updated in accordance with the contents of said configuration information acquired on said Web screen; and
execution control means for reading said UNIX-based kernel and said application for controlling the facility for said computer to provide from said partition and executing the same based on said configuration information created or updated by said configuration information creating and updating means, said UNIX-based kernel and said application being written in said partition.

21. The computer operating program according to claim 17, wherein:
the facility for said computer to provide is a server facility; and
said configuration information includes a configuration item for configuring the operation of said server facility.

22. A recording medium containing the computer operating program according to claim 17.

23. A computer comprising:
a booting unit for booting the computer by using a disk image for starting up a UNIX-based kernel, said disk image being recorded on a read only recording medium;
a file system detecting unit for detecting a file system already provided on a rewritable recording medium attached to the computer;
a free space detecting unit for detecting free space having no data written thereon out of a section of said file system detected by said file system detecting unit;
a free space read/write unit for rendering said free space detected by said free space detecting unit readable and writable of data from said UNIX-based kernel;
a partition constructing unit for constructing a partition of a UNIX-based operating system in said free space rendered readable and writable of data from said UNIX-based kernel;
a configuration information storing unit for storing, into said partition, configuration information for setting details of operation of an application for controlling a facility for the computer to provide; and
an execution control unit for reading said application for controlling the facility for the computer to provide from said read only recording medium and executing the same based on said configuration information.

24. The computer according to claim 23, further comprising:
data for displaying a Web screen for acquiring said configuration information;
a configuration information creating and updating unit for creating or updating said configuration information in accordance with the contents of said configuration information acquired on said Web screen; and
a storing unit for storing said data for displaying said Web screen and said configuration information creating and updating unit into said partition.

25. The computer according to claim 24, further comprising:
a rebooting unit for rebooting the computer after said configuration information is created or updated in accordance with the contents of said configuration information acquired on said Web screen; and
an execution control unit for reading said application for controlling the facility for the computer to provide from said read only recording medium and executing the same based on said configuration information created or updated by said configuration information creating and updating unit.

26. The computer according to claim 24, further comprising:
a rebooting unit for rebooting the computer after said configuration information is created or updated in accordance with the contents of said configuration information acquired on said Web screen; and
an execution control unit for reading said UNIX-based kernel and said application for controlling the facility for the computer to provide from said partition and executing the same based on said configuration information created or updated by said configuration information creating and updating unit, said UNIX-based kernel and said application being written in said partition.

27. The computer according to claim 23, wherein:
the facility for the computer to provide is a server facility; and
said configuration information includes a configuration item for configuring the operation of said server facility.

28. A computer comprising:
a booting unit for booting the computer by using a disk image for starting up a UNIX-based kernel;
a file system detecting unit for detecting a file system already provided on a rewritable recording medium attached to the computer;
a free space detecting unit for detecting free space having no data written thereon out of a section of said file system detected by said file system detecting unit;
a free space read/write unit for rendering said free space detected by said free space detecting unit readable and writable of data from said UNIX-based kernel;
a partition constructing unit for constructing a partition of a UNIX-based operating system in said free space rendered readable and writable of data from said UNIX-based kernel;
a storing unit for storing, into said partition, said UNIX-based kernel, an application for controlling a facility for the computer to provide, and configuration information for setting details of operation of said application; and
an execution control unit for reading said application for controlling the facility for the computer to provide from said partition and executing the same based on said configuration information.

29. The computer according to claim 28, further comprising:
data for displaying a Web screen for acquiring said configuration information;
a configuration information creating and updating unit for creating or updating said configuration information in accordance with the contents of said configuration information acquired on said Web screen; and
a storing unit for storing said data for displaying said Web screen and said configuration information creating and updating unit into said partition.

30. The computer according to claim 29, further comprising:
a rebooting unit for rebooting the computer after said configuration information is created or updated in accordance with the contents of said configuration information acquired on said Web screen; and
an execution control unit for reading said application for controlling the facility for the computer to provide from said read only recording medium and executing the same based on said configuration information created or updated by said configuration information creating and updating unit.

31. The computer according to claim 29, comprising:
a rebooting unit for rebooting the computer after said configuration information is created or updated in accordance with the contents of said configuration information acquired on said Web screen; and
an execution control unit for reading said UNIX-based kernel and said application for controlling the facility for the computer to provide from said partition and executing the same based on said configuration information created or updated by said configuration information creating/updating unit, said UNIX-based kernel and said application being written in said partition.

32. The computer according to claim 28, wherein:
the facility for the computer to provide is a server facility; and
said configuration information includes a configuration item for configuring the operation of said server facility.
